(19) United States
(12) Patent Application Publication
(10) Pub. No.: US 2007/0104340 A1
(43) Pub. Date: May 10, 2007

(54) System and Method for Manufacturing a Transducer Module

(75) Inventors: Thomas Edward Miller, Arlington Heights, IL (US); Mekell Jiles, South Holland, IL (US); Daniel Max Warren, Geneva, IL (US); Dennis Ray Kirchhoefer, Plainfield, IL (US); Angelo Assimakopoulos, Palos Park, IL (US); Vignesh Jayanth, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 11/535,736

(22) Filed: Sep. 27, 2006

Related U.S. Application Data
(60) Provisional application No. 60/721,251, filed on Sep. 28, 2005.

(51) Int. Cl. H04R 25/00

(52) U.S. Cl. 381/182

(57) ABSTRACT

A receiver includes a housing having an interior, a diaphragm assembly disposed within the housing, a motor assembly disposed within the housing and a linkage assembly coupling the diaphragm assembly and the motor assembly. A support structure joined to the diaphragm or the motor assembly or to both the diaphragm and the motor assembly. The support structure includes a cooperative surface portion engaging the housing to position and retain the joined diaphragm assembly or motor assembly within the interior. A corresponding method of manufacture employs a support structure for positioning components of the receiver in the housing. A receiver may also incorporate a microphone to through pass acoustic signals external to the receiver housing through the receiver. An earphone assembly may incorporate a receiver as described.

### CROSS-REFERENCE TO RELATED APPLICATION

This patent claims benefit under 35 U.S.C. § 119(e) to U.S. Provisional Application Serial No. 60/721,251, filed Sep. 28, 2005 and entitled Improved System and Method for Manufacturing a Transducer Module, the disclosure of which is hereby expressly incorporated herein for all purposes.

### BACKGROUND

Transducers such as receivers and speakers are particularly useful in many devices such as earphones, headphones, Bluetooth wireless headsets, cellular phones, web-enabled cellular telephones, Personal Handy-phone System (PHS), Personal Digital Assistants (PDAs), hand-held computers, notebooks, laptops, tablet computers, digital cameras, other types of portable computing and Internet access appliances and devices, capable of communication over one or more public or private communication networks, hearing aids, in-ear monitors, electronic hearing protection devices, and the like. The receiver may be used to convert electrical energy into acoustic energy and subsequently to transmit the acoustic energy to the user's ear.

A typical receiver may include such components as a top housing, a bottom housing, an acoustic assembly (e.g. a diaphragm, a ring member, flexible layer), a drive rod, and a motor assembly (e.g. an armature, a pair of drive magnet, a yoke, and a coil). Manufacture and assembly of the typical receiver may require extensive adhesive bonding and/or laser welding operations to mass produce. Moreover, the components within the housing may be adversely affected by these manufacturing and assembly processes. Also, manufacture and assembly of the receiver may require complex, labor intensive operations particularly as the size of the receiver is reduced.

The popularity of sound producing electronic devices has progressed rapidly in recent years. In particular, the use of mobile communication and entertainment devices in conjunction with headsets appeal to a growing percentage of the population. This is particularly true as consumers spend an increasing amount of time on the telephone or enjoying audio entertainment.

General speaking, conventional earphones are designed with a purpose to isolate the sound from the outside environment. This may result in hearing discomfort and eardrum injury if used improperly. Furthermore, conventional earphones tend to substantially prohibit the user's ability to simultaneously hear the electronically produced audio while at the same time hearing externally generated sound, such as a conversation.

### BRIEF DESCRIPTION OF THE DRAWINGS

For a more complete understanding of the disclosure, reference should be made to the following detailed description and accompanying drawings wherein:

FIG. 1 is a perspective view of a receiver utilized in various types of devices;

FIG. 2 is an exploded view of a described embodiment of a receiver;

FIG. 3 is a cross-sectional view of a described embodiment of a receiver shown in FIG. 2;

FIG. 4 is an exploded view of a second embodiment of a receiver;

FIG. 5 is a cross-sectional view of FIG. 4 of the second embodiment of a receiver;

FIG. 6 is an exploded view of a described embodiment of a receiver;

FIG. 7 is a cross-sectional view of the third embodiment of a receiver shown in FIG. 6;

FIG. 8 is an exploded view of a described embodiment of a receiver;

FIG. 9 is a cross-sectional view of the fourth embodiment of a receiver shown in FIG. 8;

FIG. 10 is an exploded view of a described embodiment of a receiver;

FIG. 11 is a cross-sectional view of the fifth embodiment of a receiver shown in FIG. 10;

FIG. 12 is an exploded view of a described embodiment of a receiver;

FIG. 13 is a cross-sectional view of the sixth embodiment of a receiver shown in FIG. 12;

FIG. 14 is an exploded view of a described embodiment of a receiver;

FIG. 15 is a cross-sectional view of the seventh embodiment of a receiver shown in FIG. 14;

FIG. 16 is an exploded view of a described embodiment of a receiver;

FIG. 17 is a perspective of an earphone that incorporate a receiver in accordance any of the described embodiments;

FIG. 18 is a cross-sectional view of the earphone of FIG. 17;

FIG. 19 is an exploded view of the earphone of FIG. 17; and

FIG. 20 is a perspective of a mobile device incorporating a receiver in accordance with the described embodiments.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S. C. § 112, sixth paragraph.

A receiver and a method of controlling a receiver in accordance with the herein described embodiments provide a comfortable, stabile, high sound quality receiver that allows the user to hear both electronically generated audio and external sounds. External sounds, such as voices in a conversation, pass through the earphone and combine with the electronically generated sound emitted by the receiver before being transmitted into the user's ear canal.

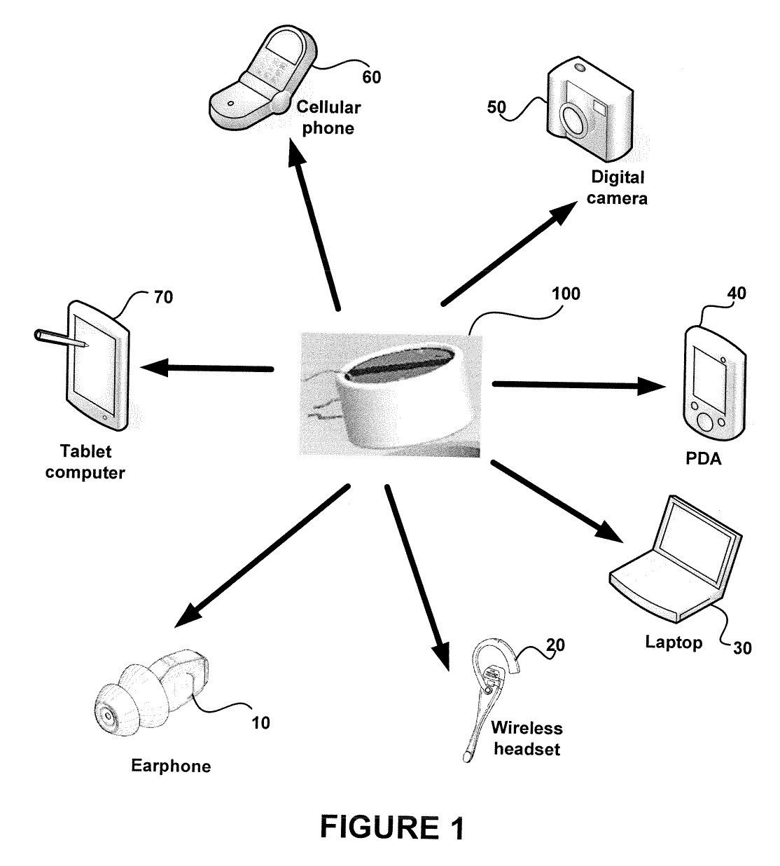

FIG. 1 illustrates the flexibility and usefulness of a receiver in accordance with one or more of the herein described embodiments. As shown, a receiver 100 may be employed in various type of devices, such as computers (e.g. desktops, laptops, notebooks, tablet computers, hand-held computers, Personal Digital Assistants (PDAs), etc), communication devices (e.g. cellular phones, web-enabled cellular telephones, cordless phones, pagers, etc), computer-related peripherals (e.g. printers, scanners, monitors, etc), entertainment devices (e.g. televisions, radios, stereos, tape and compact disc players, digital cameras, cameras, video cassette recorders, Motion Picture Expert Group, Audio Layer 3 (MP3) players, etc), listening devices (e.g. hearing aids, earphones, headphones, Bluetooth wireless headsets, insert earphone, etc) and the like, capable of communication over one or more public or private communication networks, and other such devices such as hearing aids, in-ear monitors, electronic hearing protection devices.

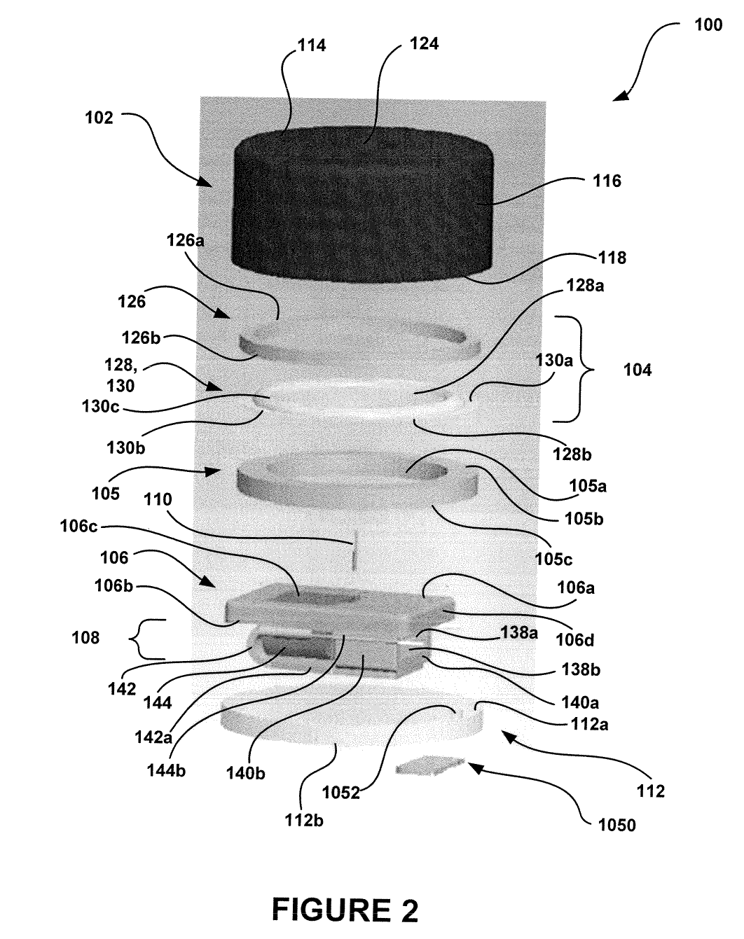

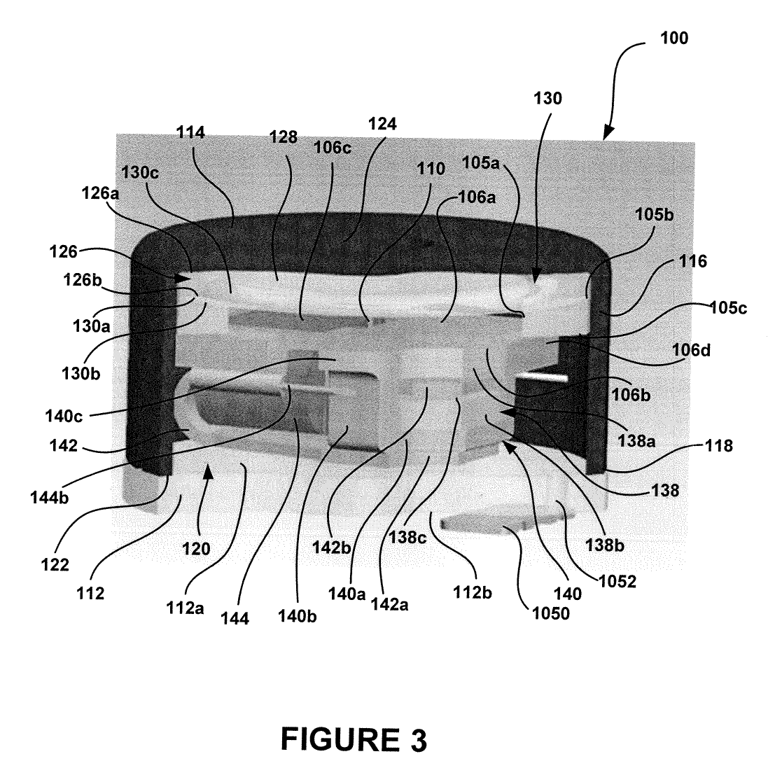

With reference to FIGS. 2-3, a receiver 100 may include an acoustic assembly 104, a spacer 105, a support structure 106, a motor assembly 108, a coupling assembly 110, and a circuit assembly 112 disposed within a receiver housing 102. The housing 102 may have a cup-shape including a first portion 114, a side wall portion 116, and a second portion 118. The housing 102 may be formed in different sizes and shapes corresponding to the assemblies 104, 105, 106, 108, 110, or 112. An opening 120 (see FIG. 3) is formed in the second portion 118 to receive the assemblies 104, 105, 106, 108, and 110. The side wall portion 116 terminates at a connecting surface 122 (see FIG. 3) and may provide a connection to the circuit assembly 112, which will be described in greater detail below. At least one aperture or acoustic port 124 may be formed in the first portion 114 of the housing 102 to allow sound waves to be transmitted to the user. A covering member (not shown) may be provided on the first portion 114 of the housing 102 for preventing damage to the acoustic assembly 104. The housing 102 may be manufactured from a variety of materials, such as, for example, aluminum, stainless steel, plastic, or combination thereof.

The acoustic assembly 104 may include a diaphragm supporting member 126, a diaphragm 128, and a flexible layer 130. However, the acoustic assembly 104 may utilize multiple diaphragm layers as disclosed in U.S. patent application Ser. Nos. 60/665,700, 10/719,809, and 09/755,664, the disclosures of which are incorporated herein by reference. The diaphragm supporting member 126 in the form of an annular ring shape may be made of electrically conductive material such as stainless steel; however, any material including tin, conductive plastic or conductive rubber may be utilized. The diaphragm 128 may have a conical shape and be made from a variety of materials having a high stiffness to mass ratio such as aluminum, stainless steel, beryllium copper, titanium, tungsten, platinum, copper, brass, or alloys thereof, non-metals such as plastic, plastic matrix, fiber reinforced plastic, etc. and combination thereof. Alternatively, the diaphragm 128 may be a planar diaphragm, a planar diaphragm with one or more ribs (See FIG. 21), or any suitable rigid shape. The flexible layer 130 may have a circular shape and be made of Mylar, urethane, or of any other similar materials. The diaphragm 128, the flexible layer 130, and the diaphragm support member 126 are attached together, for example by bonding with adhesive, welding, compression, or mechanical attachment, which then may be operably attached to the coupling assembly 110. The acoustic assembly 104 is held in contact with the inner surface of the housing 102. Generally speaking, the arrangement of the acoustic assembly 104 permits the transfer of electrical signal energy to vibrational energy in the acoustic assembly 104 or to transfer of vibrational energy in the acoustic assembly 104 into electrical signal energy.

The spacer 105 may have an annular ring shape and be made of any suitable rigid material such as molded polyethylene plastic or metal. The spacer 105 has a first surface 105a and a second surface 105b. The spacer 105 also has a thickness and is disposed between the acoustic assembly 104 and the support structure 106, its thickness enabling deflection of the acoustic assembly 104. The first surface 105a of the spacer 105 is held in place with the acoustic assembly 104 by any suitable means.

The support structure 106 may have an almost rectangular shape and may be formed with an opening 106c. The support structure 106 further includes a first surface 106a, a second surface 106b, and side walls 106d. The corners of the side walls 106d of the support structure 106 may correspond to the inner round surface of the housing 102 and may be held in contact with the housing 102 at its inner surface. The support structure 106 forms part of the motor assembly 108 to carry the electromagnetic flux, which will be described in greater detail below, and may be made of a Nickel-Iron alloy, an Iron-Cobalt-Vanadium alloy or of any other similar materials. As shown in FIG. 3, the support structure 106 may be connected at the comers of its first surface 106a to the second surface 105b of the spacer 105 by any suitable means. The opening 106c permits the coupling assembly 110 to pass through, which then may be operably attached the motor assembly 108 to the acoustic assembly 104.

The motor assembly 108 may include a pair of drive magnets 138, a magnetic yoke 140, an armature 142, and a field coil 144. The magnetic yoke 140 may have a U-shape and may be made of a Nickel-Iron alloy, an Iron-Cobalt-Vanadium alloy or of any other similar materials. The U-shape magnetic yoke 140 has a base portion 140a and side walls 140b connecting to the base portion 140a. The side walls 140b terminate at outward flares 140c that may receive the support structure 106. Alternatively, the magnetic yoke 140 having ends at the side walls 140b enabling to receive the support structure 106 directly without any introduction of the outward flares 140c as depicted earlier. The drive magnet 138 may have a rectangular shape and may be made of a magnetic material such as Ferrite, AlNiCo, a Samarium-Cobalt alloy, a Neodymium-Iron-Boron alloy, or of any other similar materials. First and second drive magnets 138a, 138b may be fixedly attached to the magnetic yoke 140 such that the first drive magnet 138a is aligned with the outward flares 140b and is mounted within the magnetic yoke 140. The second drive magnet 138b may be mounted to the inner base surface of the magnetic yoke 140. A first air gap 138c may be formed between the first and second drive magnet 138a, 138b to receive the armature 142 (see FIG. 3). The coil 144 may be formed by winding a conductive wire around a disposable bobbin (not shown). Alternatively, the bobbin may form part of the coil 144 and is disposed within the receiver housing 102. The coil 144 defines a second air gap (not shown) adjacent to the first air gap 138c to receive the armature 142. Coil terminals 144b are extended from the outmost for electrical connection to an electrical interface (not shown). The armature 142 may have a generally U-shaped strap with a fixed end 142a and a movable end 142b. The movable end 142b of the armature 142 extends through the first air gap 138c and the second air gap (not shown). One skilled in the art will appreciate the principles and advantages of the embodiments described herein may be useful with all types of receivers, such as those using an E-shaped armature or of a different configuration such as disclosed in U.S. patent application Ser. Nos. 10/769,528 and 10/758,441, the disclosures of which are incorporated herein by reference. As depicted, the motor assembly 108 is fitted underneath the support structure 106 wherein the first drive magnet 138a and the outward flares 140c of the magnetic yoke 140 are fixedly attached to the inner surface of the support structure 106 to complete the magnetic circuit and at least a portion of the coil 144 is disposed within the opening 106c of the support structure 106 leaving the side walls 106d covering at least a portion of the motor assembly 108.

The coupling assembly 110 may be a drive rod, a linkage assembly, a plurality of linkage assemblies, or the like and may be made of electrically conductive material. One end of the coupling assembly 110 is coupled to the acoustic assembly 104 via the openings 106c, 105a of the support structure 106 and the spacer 105, respectively, and the other end of the coupling assembly 110 may be coupled to the movable end 142b of the armature 142 to drive the acoustic assembly 104.

The circuit assembly 112 may have a circular shape with a first surface 112a and a second surface 112b. The first surface 112a of the circuit assembly 112 may be held in contact with the connecting surface 122 of the housing 102 by suitable means. The housing 102 and the circuit assembly 112 collectively form a cylindrical housing of the receiver 100. Manufacture and assembly of the receiver 100 may require less adhesive bonding and/or laser welding operations as the working components are looked in position once the circuit assembly 112 are held in place with the connecting surface 122 of the housing 102 in the final closure.

In operation, the effect of the receiver 100 is described below. A current representing an input audio signal from the coil terminals 144b are applied to the coil 144, a corresponding alternating current (a.c.) magnetic flux (not depicted) is produced from the coil 144 through the armature 142, drive magnets 138, the magnetic yoke 140, and the support structure 106. Further, a corresponding direct current (d.c.) magnetic flux path (not shown) is produced by the drive magnet 138 within the magnetic yoke 140 and across the first air gap 138c. The movable end 142b of the armature 142 vibrates in response to the electromagnetic forces generated by the magnetic flux produced by the drive magnet 138, the magnetic yoke 140, the support structured 106, and the coil 144, which in turn, leads to the movement of the coupling assembly 110. The acoustic assembly 104 moves in response to the vertical motion of the armature movable end 142b driven by the coil 144. The receiver 100 utilizes the corresponding motion of the armature movable end 142b and the acoustic assembly 104 to generate an output sound signal towards the user's eardrum.

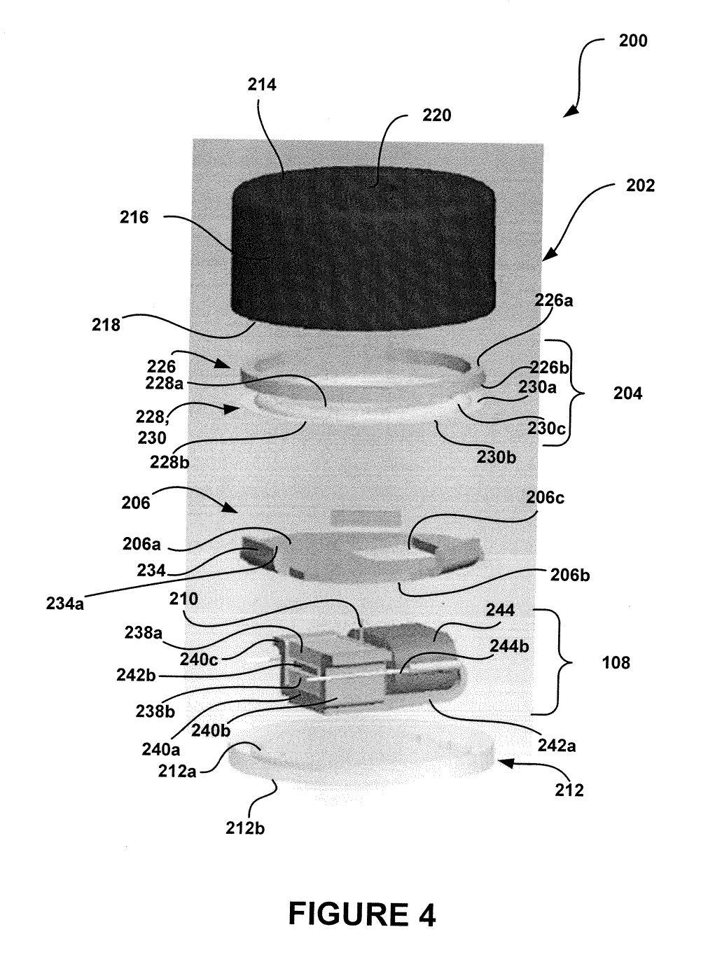

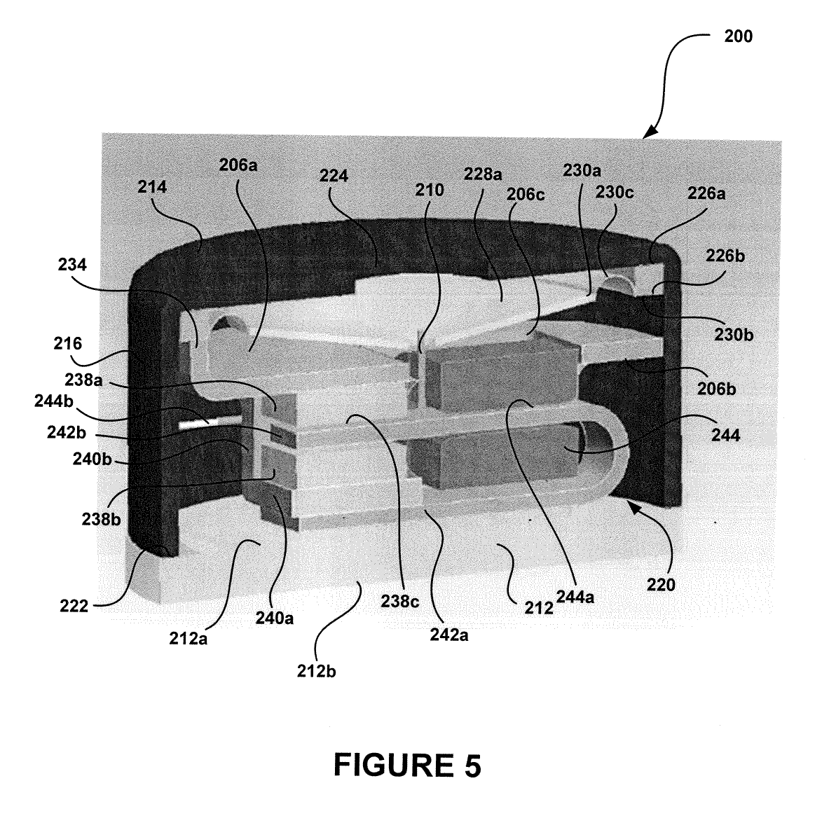

FIGS. 4-5 illustrate another of the herein described embodiments of a receiver, and particularly, the receiver 200. The receiver 200 may be similar in construction and function as the receiver 100 illustrated in FIGS. 2-3, and similar elements are referred to with like reference numerals wherein, for example, 202 and 204 correspond to 102 and 104, respectively. In contrast to the receiver 100, for the receiver 200, the spacer 105 as illustrated in FIG. 2-3 is omitted. A support structure 206 is provided within the housing 202 to hold the motor assembly 208 in place. The support structure 206 reduces manual assembly labor and provides a less complex assembly that is easily reproduced. The support structure 206 may have a circular shape that corresponds to the shape of the housing 202, secures the working components within the housing 202, and forms part of the motor assembly 108 to carry the electromagnetic flux of the drive magnet 238 and the magnetic yoke 240. During assembly the support structure 206 facilitates the attachment of the acoustic assembly 204 to the housing 202.

A plurality of outward flares 234 may be formed in a circumferential direction to receive the acoustic assembly 204. As shown in FIG. 4, three outward flares 234 are bent or formed at an angle parallel to the side walls 216 and further may be arranged at intervals of 120 degree, however, the number of outward flares and their arrangement may be configured for particular applications. The support structure 206 may be formed, for example by molding, in various shapes and size to suit the needs of the application. The support structure 206 may further be the same material as the magnetic yoke 240. Three end portions 234a of the outward flares 234 are held in contact with the outer rim of the acoustic assembly 204 to enable deflection of the acoustic assembly 204 at a preadjusted distance. As shown in FIG. 5, the outward flare 240b of the magnetic yoke 240 and the first drive magnet 238a are held in contact with the second surface 206b of the support structure 206 to complete the magnetic circuit and a portion of the coil 244 is disposed within the opening 206c of the support structure 206.

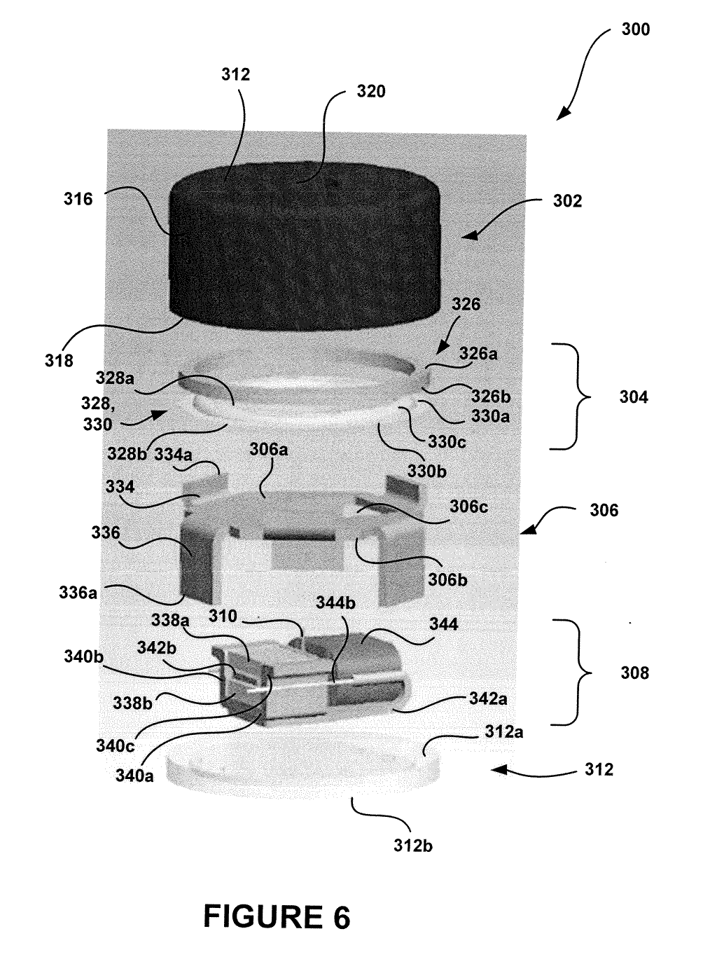

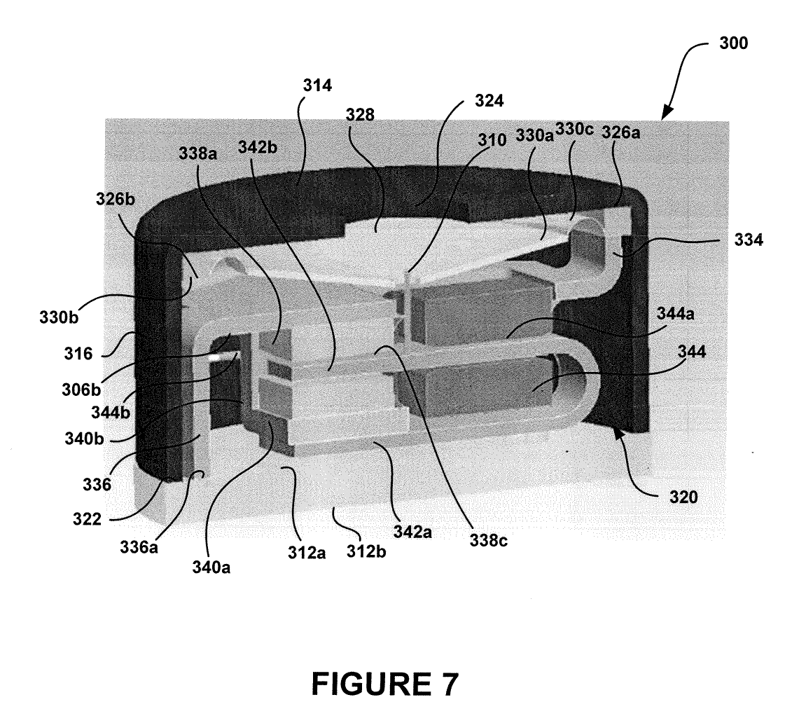

FIGS. 6-7 illustrate another of the herein described embodiments of a receiver, and in particularly, a receiver 300. The receiver 300 is similar in construction and function as the receiver 200 illustrated in FIGS. 4-5, and similar elements are referred to with like reference numerals wherein, for example, 302 and 304 correspond to 202 and 204, respectively. In this embodiment, a plurality of downward flares 336 may be formed having end portions 336a. The three downward flares 336 may be bent or formed at an angle parallel to the side walls 316 of the housing 302 and may be arranged at intervals of 120 degree between the outward flares 334; however, the number of outward flares and their arrangement may be configured to different applications. The length of the downward flares 336 may be longer than the length of the outward flares 334 to accommodate the motor assembly 308. The outward flare 340b of the magnetic yoke 340 and the first drive magnet 338a may be held in contact with the second surface 306b of the support structure 306. At least a portion of the coil 344 may be disposed within the opening 306c of the support structure 306. The first surface 312a of the circuit assembly 312 is held in contact with the connecting surface 322 of the housing 302 by suitable means. The housing 302 and the circuit assembly 312 collectively form a cylindrical housing of the receiver 300. The arrangement of the support structure 306 permits centering of the motor assembly 308 within the housing 302 and further forms part of the motor assembly 308 to carry the electromagnetic flux of the drive magnet 338 and the magnetic yoke 340.

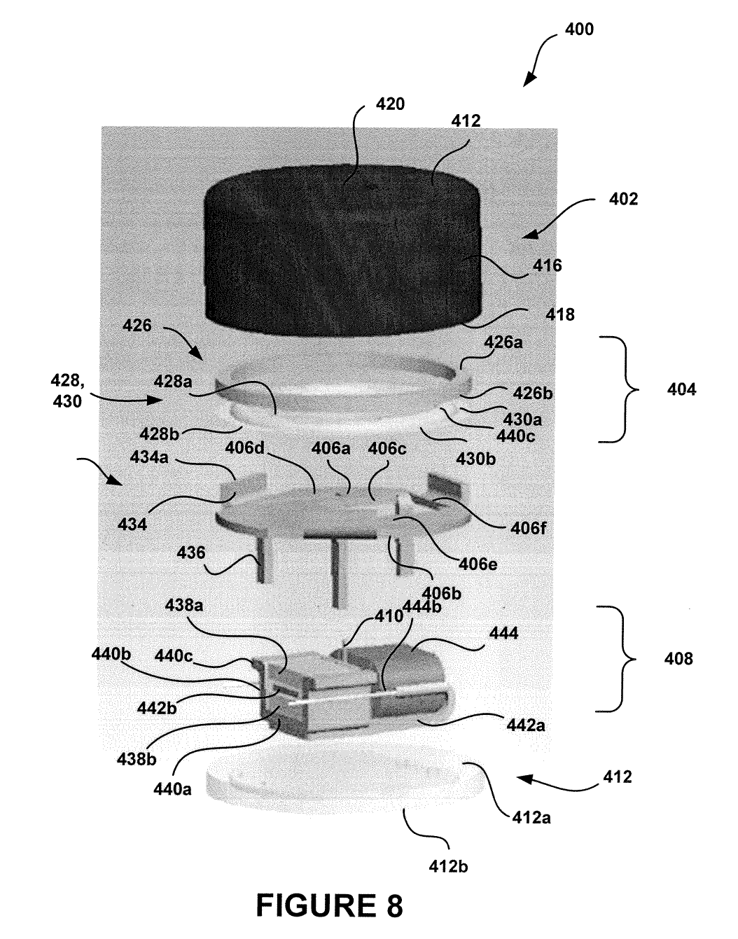

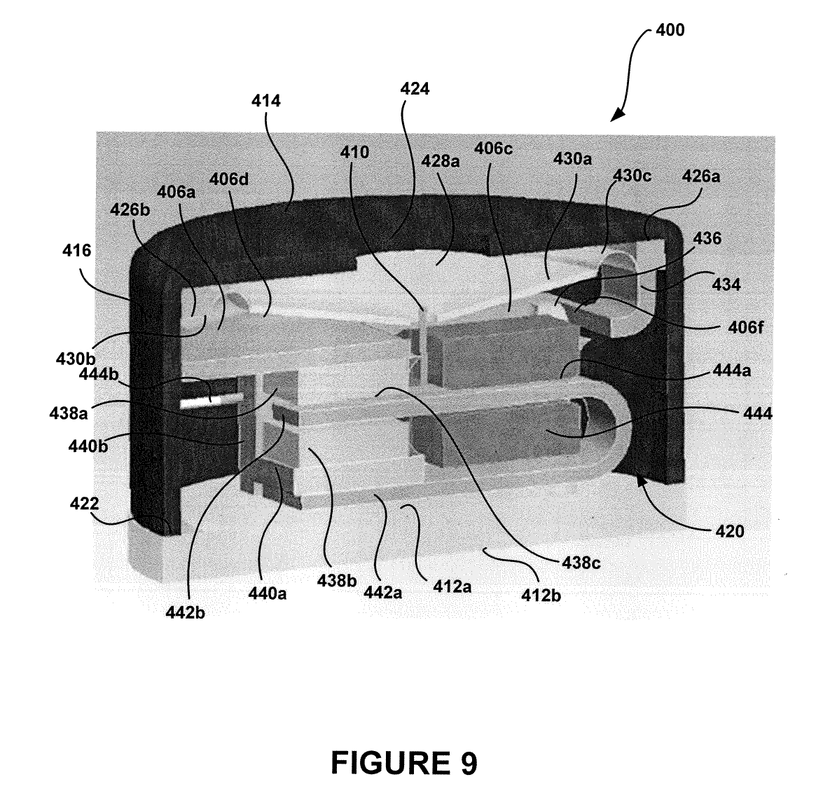

FIGS. 8-9 illustrate another of the herein described embodiments of a receiver, and in particular a receiver 400. The receiver 400 is similar in construction and function as the receiver 300 illustrated in FIGS. 6-7, and similar elements are referred to with like reference numerals wherein, for example, 402 and 404 correspond to 302 and 304, respectively. In order to provide a space for inserting the drive magnet 438, a plurality of openings 406d, 406e, and 406f may be formed to retain the motor assembly 408 in place instead. Furthermore, instead of forming the downward flares at the outer rim of the support structure 306 as shown in FIGS. 6-7, two downward flares 436 may be formed from a cut out corresponding to a portion of the openings 406d, 406e where one end of the downward flares 436 remains attached to the openings 406d, 406e. The opening 406f may be formed adjacent to the opening 406c and may further provide additional accommodation to the motor assembly 408. A third downward flare 436 may be formed from a cut out corresponding to a portion of the opening 406f where one end of the downward flare 436 remains attached at the opening 406f. The length of the downward flares 436 are longer than the length of the outward flares 434 and the width of the downward flares 436 are narrower than the width of the outward flares 434. Outward flares 440c and the first drive magnet 438a are held in contact with the second surface 406b of the support structure 406 to complete the magnetic circuit of the drive magnet 438 and the magnetic yoke 440. At least a portion of the coil 444 is disposed within the combined opening 406c, 406f and the openings 406d, 406e of the support structure 406. The first surface 412a of the circuit assembly 412 is held in contact with the connecting surface 422 of the housing 402 by suitable means. The housing 402 and the circuit assembly 412 collectively form a cylindrical housing of the receiver 400.

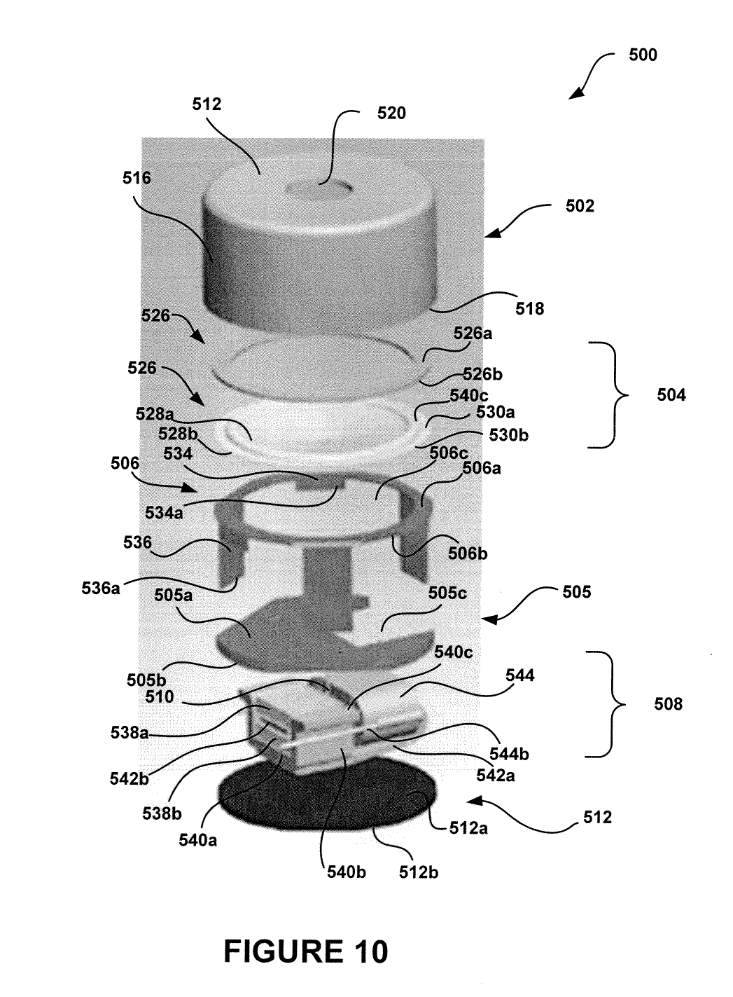

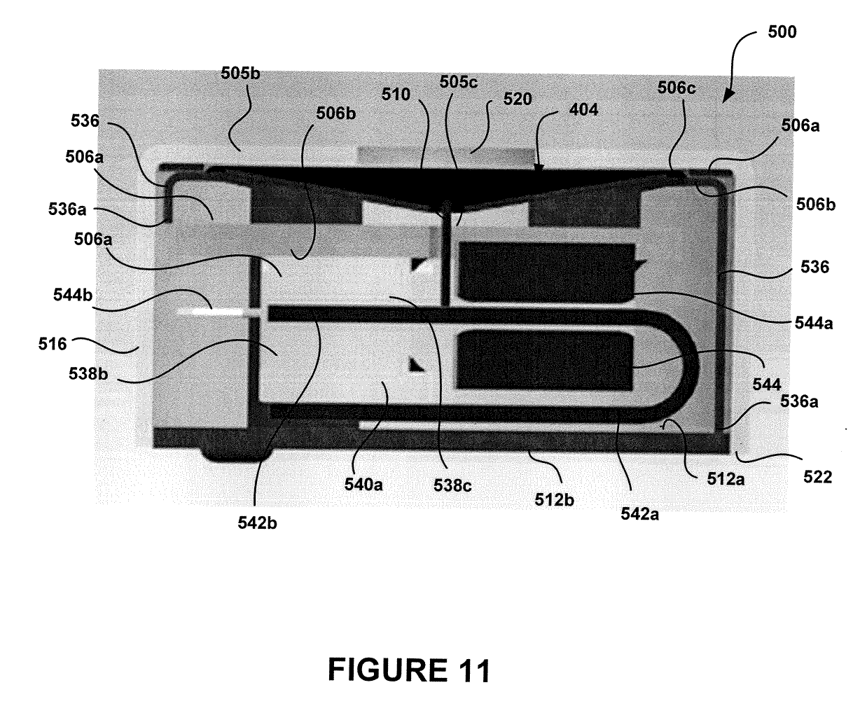

FIGS. 10-11 illustrate another herein described embodiment of a receiver, and in particular the receiver 500. The receiver 500 is similar in construction and function as the receiver 200 illustrated in FIGS. 4-5, and similar elements are referred to with like reference numerals wherein, for example 502 and 504 correspond to 202 and 204, respectively. In the receiver 500, instead of bending outward flares upward, as shown in connection with the outward flares 234 in FIGS. 4-5, outward flares 524 are bent downward in the same direction of the plurality of downward flares 536. A circular, which hollow section 532 may be formed in the central portion of the support structure 506 may be made of any rigid material such as molded polyethylene plastic or metal, to allow deflection of the acoustic assembly 504. An almost V-shape spacer 505, which may be the same material as the magnetic yoke 540, substantially corresponds to the shape of the support structure 506 but may take the form of various shapes and has a number of different of sizes in different embodiments is provided below the support structure 506 instead of above the support structure 105 as depicted in FIGS. 2-3. The spacer 505 has a first surface 505a, a second surface 505b, and is formed with a U-shaped cut out portion 505c. As shown in FIG. 11, the second surface 505b of the spacer 505 is held in contact with the outward flares 540c of the magnetic yoke 540 to carry the electromagnetic flux of the drive magnet 538 and the magnetic yoke 540 and a portion of the coil 544 is disposed with the U-shaped cut out portion 505c of the spacer 505. The acoustic assembly 504 may be held in contact with the outer rim of the support structure 506 for providing a support means to the acoustic assembly 504 and the end portion 534a of the downward flare 534 may be held in contact with the with first surface 505a of the spacer 505 to provide a proximity relationship between the acoustic assembly 504 and the spacer 505 and to permit further deflection of the acoustic assembly 504. An outward flare (not shown) may be located at the opening 520 where it is bent or formed radially toward the center of the opening 520 to define a connecting surface 522. This forming operation mechanically captures the circuit assembly 512 by the connecting surface 522, locking all the working components in position. In this manner, the press-fit of the support structure 506 restrains the assemblies 504, 505, 508, and 510 to reduce shifting and deformation that may occur during manufacturing.

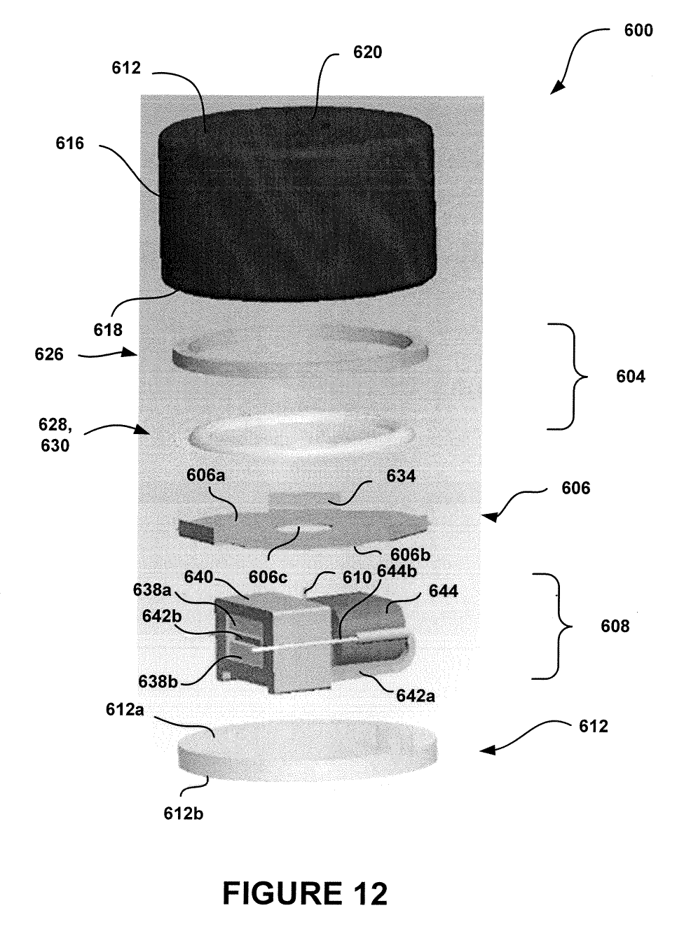

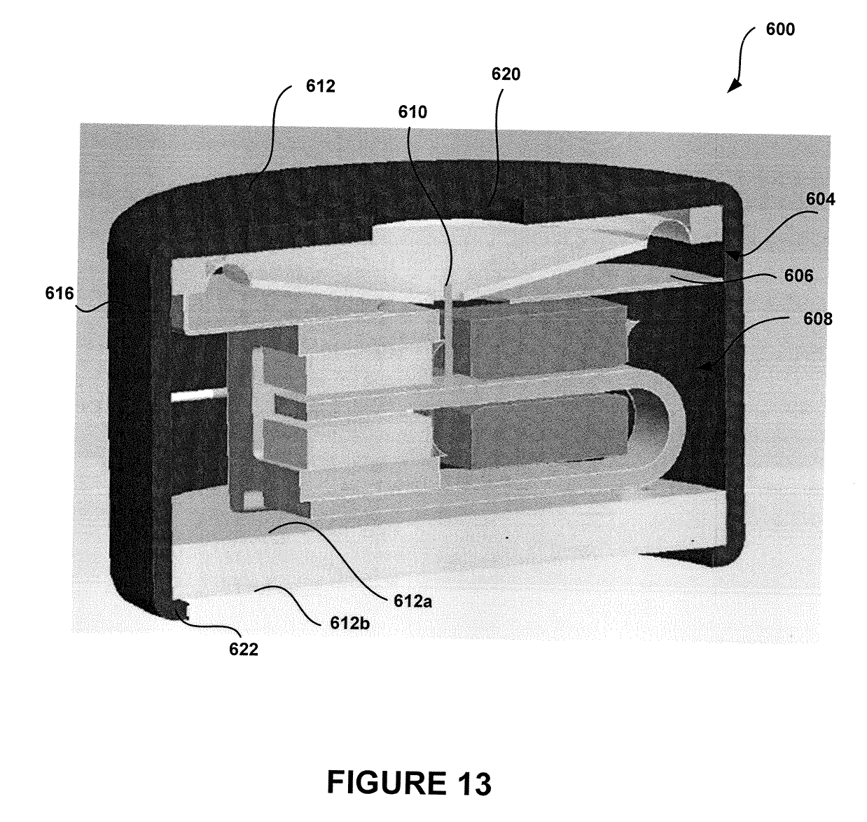

FIGS. 12-13 illustrate another of the herein described embodiments of a receiver, and in particular a receiver 600. The receiver 600 is similar in construction and function as the receiver 200 illustrated in FIGS. 4-5, and similar elements are referred to with like reference numerals wherein, for example 602 and 604 correspond to 202 and 204, respectively. In this embodiment, a support structure 606 may be made of any rigid material such as molded polyethylene plastic or metal has a hollow section 606c formed in the center of the support structure 606 to receive the coupling assembly 610. The magnetic yoke 640 in the form of a frame having a central tunnel defining an enclosure into which the drive magnet 638 mounts is formed. As depicted in FIG. 13, an outward flare 603 is located at the opening 618 where it is bent or reformed radially toward the center of the opening 620, defining a connecting surface 622. This forming operation mechanically captures the circuit assembly 612 by the connecting surface 622, locking all the working components in position. The first surface 606a of the support structure 606 is held in contact with the acoustic assembly 604 by the mechanical pressure of the connecting surface 622 and the second surface 606b of the support structure 606 is held in contact with motor assembly 608. In this manner, the press-fit of the support structure 606 restrains the assemblies 604, 608, and 610 to reduce shifting and deformation that may occur during manufacturing.

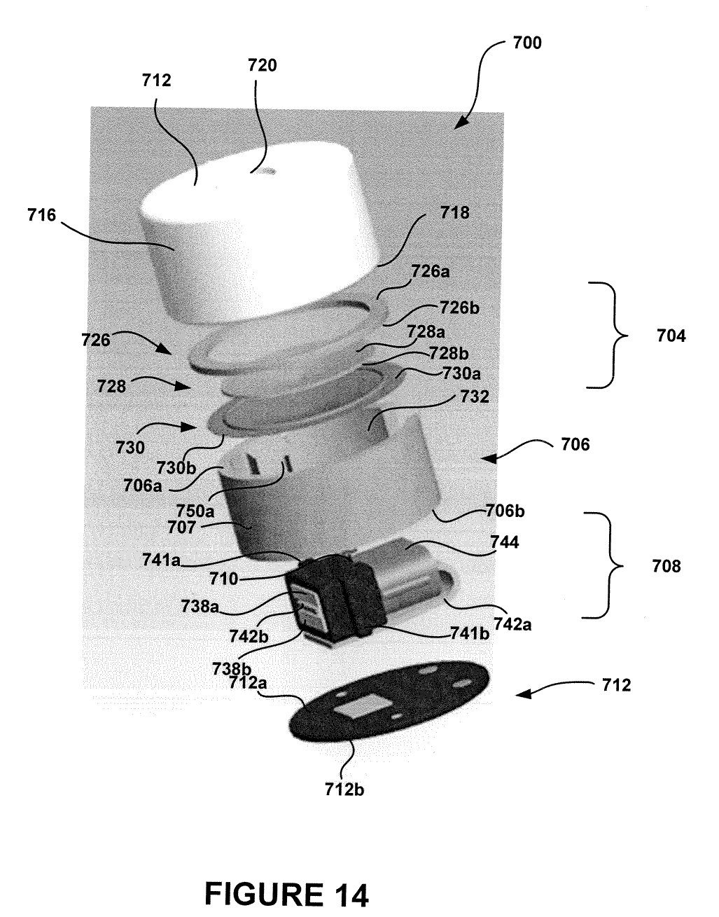

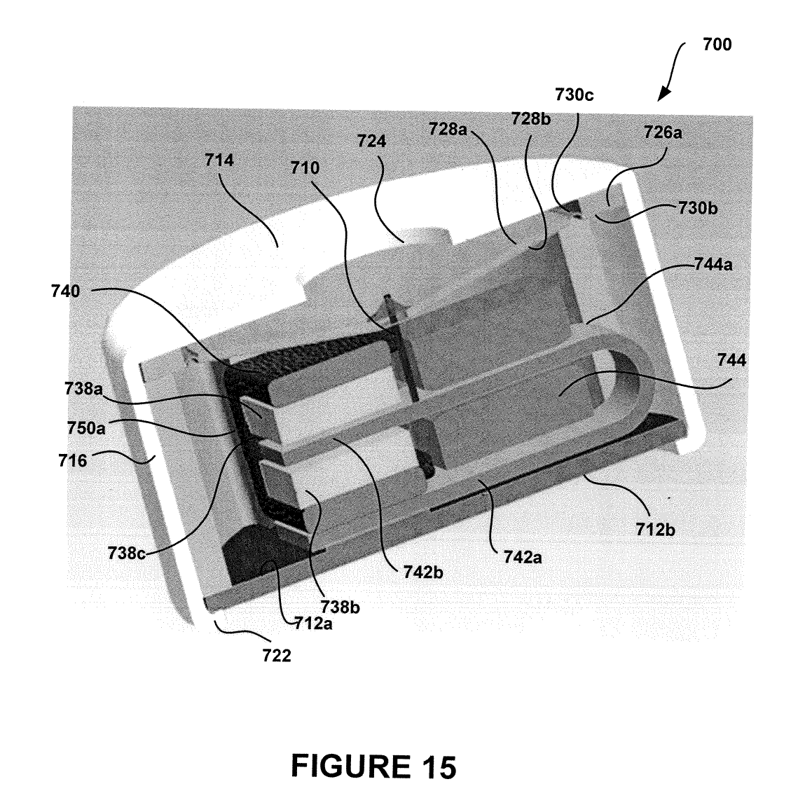

FIGS. 14-15 illustrate another of the herein described embodiments of a receiver, and in particular a receiver 700. The receiver 700 is similar in construction and function as the receiver 200 illustrated in FIGS. 4-5, and similar elements are referred to with like reference numerals wherein, for example 702 and 704 correspond to 202 and 204, respectively. In this embodiment, a support structure 706 may be made of any suitably rigid material such as molded polyethylene plastic or metal to have a body section 707 that is pressed or molded in the form of a C-shaped cylindrical structure. The body section 707 may have a hollow section 732 and first and second surfaces 706a and 706b, respectively. Two mounting slots 750a and 750b may be formed within the inner surface of the body section 707 to receive two protrusions 741a, 741b of the magnetic yoke 140. The support structure 706 restrains the motor assembly 708 to reduce shifting and damage that may occur during the manufacturing process. Further, the support structure 706 makes it possible to connect the acoustic assembly 704 and the coupling assembly 710 without deformation therein. Alternatively, the support structure 706 may be a cylindrical holder with a top opening to receive the acoustic assembly 704 and a bottom opening to receive the motor assembly 708. As depicted in FIG. 15, an outward flare 703 may be located at the opening 720 where it is bent or formed radially toward the center of the opening 720, defining a connecting surface 722. This forming operation mechanically captures the circuit assembly 712 by the connecting surface 722 locking all the working components in position. A first surface 706a of the support structure 710 may be held in contact with the acoustic assembly 704 by the mechanical pressure of the connecting surface 722 and the second surface 706b of the support structure 710 may be held in contact with the circuit assembly 712. In this manner, the press-fit of the support structure 710 restrains the assemblies 704, 706, 108, and 710 to reduce shifting and deformation that may occur during manufacturing.

As the size of the transducer is further reduced, the length of the armature is reduced and therefore raises the rigidity of the armature. In order to drive the acoustic assembly fixedly coupled to the armature via the coupling assembly, the needed properties of the magnetic yoke, drive magnet, and the coil increase proportionally to accommodate the rigid armature.

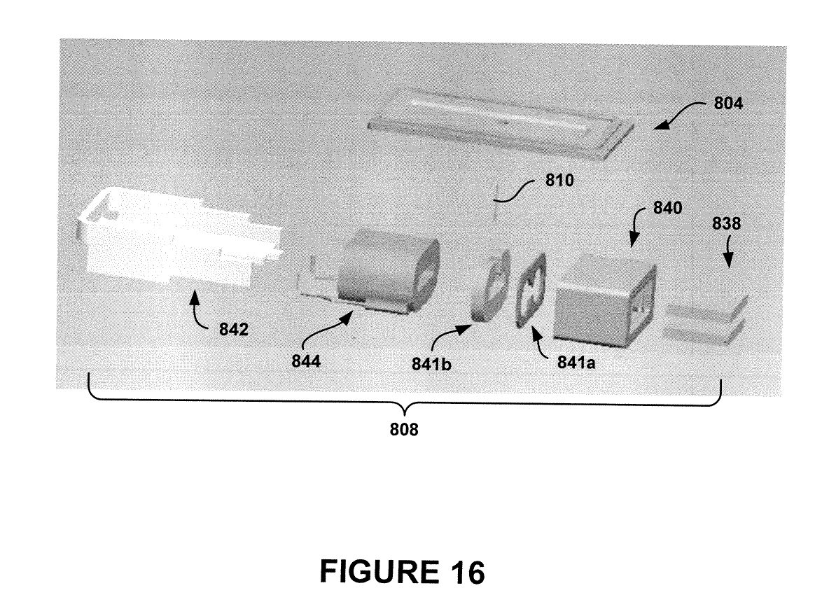

FIG. 16 illustrates an exploded view of an improved motor assembly 808 for use with any one or more of the herein described embodiments. To reduce the susceptibility to shocks, a snubber 841a is provided to prevent potentially damaging deflections that may occur on the armature 842. The snubber 841 a may be formed on the frame and have a shape that corresponds to the shape of the magnetic yoke 840. The snubber 841a further may be made of stainless steel attached to the rear end of the magnetic yoke 840, although other materials including elastomeric material may be used. The motor assembly 808 further comprises a C-shape positioning member 841b for retaining a coupling assembly 810 and may be made from the same material as the snubber 841a. The positioning member 841b is sandwiched between the coil 844 and the snubber 841a. The armature 842 may extend through the air gap formed within the coil 844, the positioning member 841b, snubber 841a, and the drive magnet 838 disposed within the magnetic yoke 840. Alternatively, the snubber 841a, the positioning member 841b, and the coil 844 may be molded into one piece to simplify the assembly during mass production.

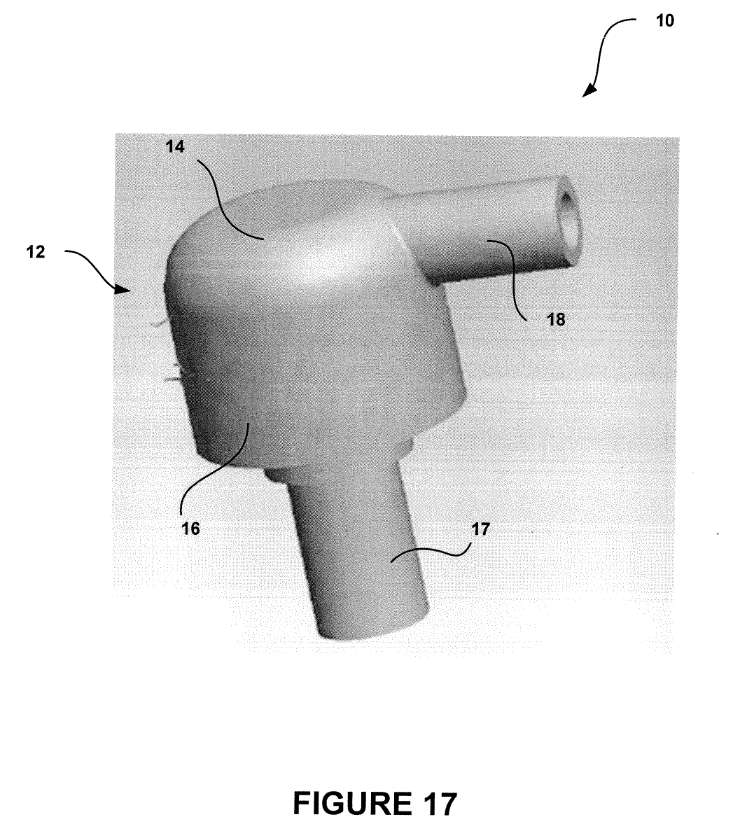

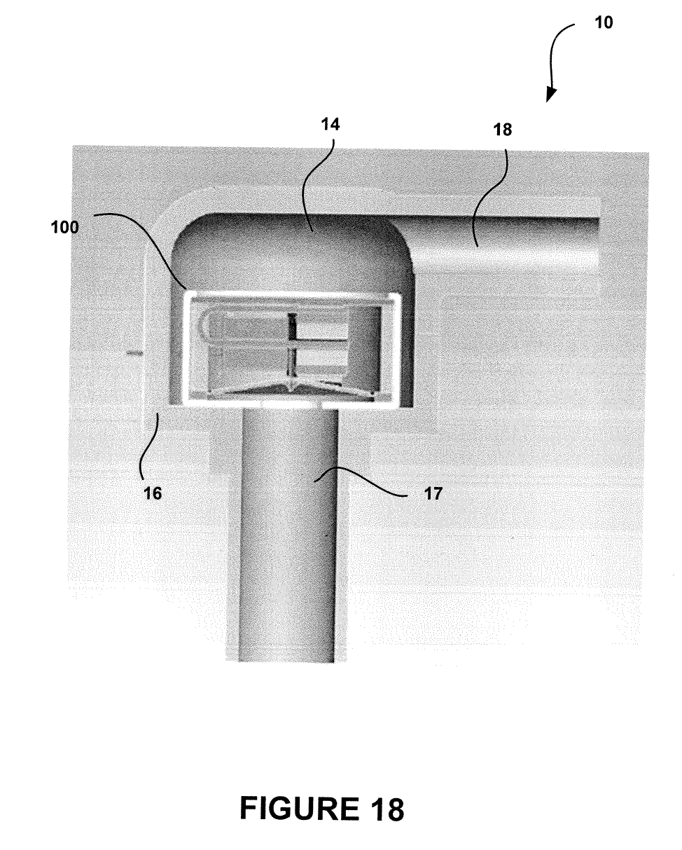

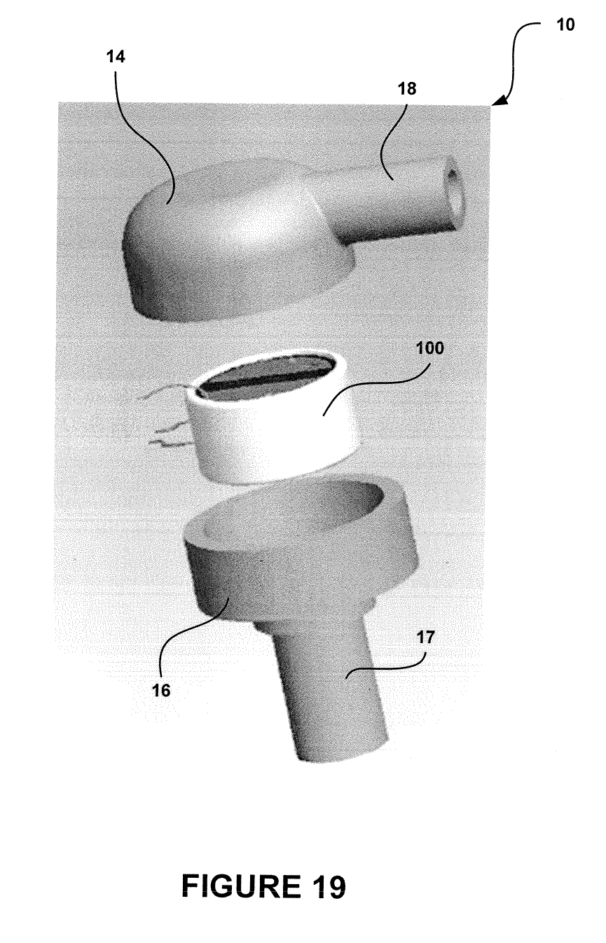

With reference to FIGS. 17-19, an earphone is shown and is designated generally 10. For purposes of describing the earphone 10, it is referred to as incorporating a transducer, for example a receiver 100. However, the earphone may incorporate a transducer in accordance with any one or more of the herein described embodiments. Furthermore, while described separately, the features and advantages of any of the herein described embodiments of a transducer may be utilized in any other of the herein described embodiments and in other embodiments of a transducer. The earphone 10 includes a main body 12 having a housing within which at least one transducer, e.g., a receiver 100 is mounted. A sound passage tube 17 and a cord supporting member 18 are integrally formed with the main body 12. In one embodiment, the main body 12 includes a top cover 14 and a bottom cover 16 securely attached to the top cover 14 for accommodating the receiver 100. An optional sound passage tube 17 is integrally formed with the bottom cover 16 to facilitate communication of sound waves from the receiver 100 directly to the ear canal for preventing sound leakage. The front end of the sound passage tube 17 may be covered with a screen element (not shown), which may further incorporate acoustic properties, such as damping, for preventing the entry of debris and the like. A complaint sleeve, such as a rubber sleeve, (not shown) may be fitted to the sound passage tube 17 for providing comfort in wearing the earphone 10 in the ear canal. The cord supporting member 18 is integrally formed with the top cover 14 to guide the wire (not shown) from the receiver 100 to a device that has an audio output port. The main body 12 can be manufactured in a variety of configurations, including a roughly circular shape, a cup shape or any other desired geometry. The main body 12 may be made from a variety of materials, such as plastic. The interior recess of the sound passage tube 18 is configured to be large enough to overlap with an acoustic port of the transducer, for example, the acoustic port 124 (see FIG. 2) of the receiver 100, to direct the acoustic sound waves emitted from the acoustic port to the ear canal via the sound passage tube 17 of the earphone 10.

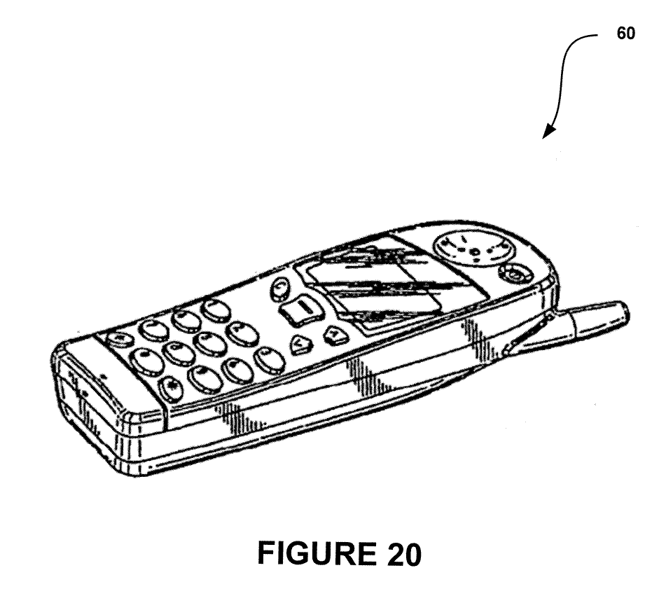

FIG. 20 illustrates a perspective view of a hand-held wireless communication device 60, such as a cellular phone. A transducer in accordance with any of the herein described embodiments or any other embodiments of a transducer, for example, a receiver 100, is mounted within the device 60. More specifically, the transducer is electrically connected to a printed circuit board (not shown) residing in the device 60. Alternately, the transducer may be joined to the device 60 to form a portion of the device housing.

At least one transducer may be coupled to a circuit assembly residing in the receiver housing. The transducer may be a microphone 1050 (see FIGS. 2-3), a second receiver as disclosed in U.S. Ser. No. ______, or combination thereof.

At least one microphone 1050 (see FIGS. 2-3) may be coupled to a circuit assembly residing in the receiver housing to sense sound from outside the ear canal, the sound in the ear canal, and/or the sound from the audio devices. Alternatively, a via 1052 may be formed to couple the microphone 1050 mounted on a rear surface, i.e. second surface of the circuit assembly to the receiver, for example. A microphone, such as the microphone 1050 may be incorporated into any one or more of the herein described embodiments of a transducer/receiver. Furthermore, while described separately, the features and advantages of any of the herein described embodiments of a receiver 100 may be utilized in any other of the herein described embodiments and in other embodiments of a transducer. The microphone and the receiver have furthermore shown a common housing feature. That is, the microphone and receiver may be conjoined. The combined sound from the outside and the audio device are realized and transmitted to the user's ear. A control means may couple the microphone 1050 to the receiver, the conjoined microphone and receiver module, or any communication devices to perform multiple functions, such as but are not limited to, the sound level control, noise reduction, talk through, equalization, signal mixing, and/or data storage/memory. Such means may be provided as an internal control interface and/or external control interface.

All references, including publications, patent applications, and patents, cited herein are hereby incorporated by reference to the same extend as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A receiver comprising:
a housing having an interior;
a diaphragm assembly disposed within the housing;
a motor assembly disposed within the housing;
a linkage assembly coupling the diaphragm assembly and the motor assembly; and
a support structure joined to the diaphragm or the motor assembly or to both the diaphragm and the motor assembly, the support structure including a cooperative surface portion engaging the housing to position and retain the joined diaphragm assembly or motor assembly within the interior.

2. The receiver of claim 1, the support structure joined to each of the diaphragm assembly and the motor assembly.

3. The receiver of claim 1, the support structure comprising a first support member joined to the diaphragm assembly and a second support member joined to the motor assembly, each of the first support member and the second support member comprising cooperative surface portions engaging the housing interior.

4. The receiver of claim 1, the cooperative surface portion comprising a first cooperative surface portion engaging the housing to position and retain the joined diaphragm or motor assembly in a first direction within with the interior and the a second cooperative surface portion engaging the housing to position and retain the joined diaphragm or motor assembly in a second direction within the interior.

5. The receiver of claim 1, the support structure comprising a flange, the cooperative surface portion formed on the flange.

6. The receiver of claim 1, the support structure comprising a flange, the cooperative surface portion comprising a first cooperative surface portion formed on the flange engaging the housing to position and retain the joined diaphragm or motor assembly in a first direction within with the interior and the a second cooperative surface portion formed on the flange engaging the housing to position and retain the joined diaphragm or motor assembly in a second direction within the interior.

7. The receiver of claim 1, wherein the support structure comprises a first flange extending from a surface of the support structure in a first direction and a second flange extending from the surface of the support structure in a second direction, the first flange engaging the housing and the second flange engaging the diaphragm assembly to position the joined diaphragm assembly or motor assembly in a first direction within the housing and to position the diaphragm assembly with respect to the motor assembly in the first direction.

8. The receiver of claim 1, wherein the support structure comprises a flange formed on periphery portion of the support structure and a post member formed internally of the periphery portion, the cooperative surface being formed on the flange to position the joined diaphragm assembly or motor assembly in a first direction and the post member engaging the housing to position the joined diaphragm assembly or motor assembly in a second direction.

9. The receiver of claim 1, the support structure comprising an aperture, the motor assembly being secured within the aperture.

10. The receiver of claim 1, the support structure comprising a first surface and a second surface spaced in a first direction relative to the first surface, the diaphragm assembly being joined to the first surface and the motor assembly being joined to the second surface.

11. The receiver of claim 9, the support structure comprising a flange extending from one of the first surface or the second surface, the cooperative surface being formed on the flange.

12. The receiver of claim 1, wherein the support structure comprises a partial cylinder having an inner surface and an outer surface and first and second end surfaces, the cooperative surface comprising a first cooperative surface formed on the outer surface to position the joined diaphragm assembly or motor assembly in a first direction and second cooperative surface formed on one of the first or second end surfaces to position the joined diaphragm assembly or motor assembly in a second direction.

13. The receiver of claim 1, disposed within a cellular phone, a digital camera, a personal digital assistant, a laptop computer, a wireless headset, an earphone or a tablet computer.

14. A method of producing a receiver, the receiver including a housing, a diaphragm assembly, a motor assembly and a linkage assembly joining the motor assembly and the diaphragm assembly, the method comprising:
providing a support structure;
joining the diaphragm assembly, the motor assembly or both the diaphragm assembly and the motor assembly to the support structure;
engaging a cooperative surface of the support structure with an interior surface of the housing to position and retain the joined diaphragm assembly or motor assembly within the housing.

15. A receiver comprising:
a housing;
a diaphragm assembly and a motor assembly coupled by a linkage to the diaphragm assembly disposed within the housing; and
a signal processing circuit coupled to the motor assembly and an input audio signal, signal processing circuit driving the motor assembly responsive to the input audio signal to cause audible reproduction of the input audio signal by the diaphragm; and
a microphone coupled to the signal processing circuit, the microphone operable to receive acoustic signals external to the housing and to provide to the signal processing circuit a secondary input audio signal representative of the acoustic signals, the signal processing circuit driving the motor assembly responsive to the secondary input audio signal to cause audible reproduction of the acoustic signals in conjunction with the input audio signal by the diaphragm.

16. The receiver of claim 14, the microphone being joined to the housing.

17. The receiver of claim 14, the microphone being disposed within the housing.

18. An earphone comprising:
a body having a first portion and a second portion defining a chamber;
a receiver disposed within the chamber;
a sound passage tube extending from the body and acoustically coupled to the chamber; and
a cord support member extending from the body providing a conduit passage for an electrical cord to the receiver.
